(19) United States
(12) Patent Application Publication
(10) Pub. No.: US 2010/0207536 A1
(43) Pub. Date: Aug. 19, 2010

(54) HIGH EFFICIENCY LIGHT SOURCE WITH INTEGRATED BALLAST

(75) Inventors: Robert J. Burdalski, Lumberton, NJ (US); Stephen Sundell, Cherry Hill, NJ (US)

Correspondence Address: CANTOR COLBURN, LLP, 20 Church Street, 22nd Floor, Hartford, CT, 06103, US

(73) Assignee: LIGHTING SCIENCE GROUP CORPORATION, Satellite Beach, FL (US)

(21) Appl. No.: 12/738,342

(22) PCT Filed: Oct. 27, 2008
(86) PCT No.: PCT/US08/81383

§ 371 Date: Apr. 16, 2010

Related U.S. Application Data
(60) Provisional application No. 60/983,043, filed on Oct. 26, 2007.

(51) Int. Cl. H05B 37/02

(52) U.S. Cl. 315/224

(57) ABSTRACT

The present invention relates to regulated power supplies or ballasts integrated with an LED light source. The invention provides a power factor correction scheme producing a greater circuit power factor and improved frequency spectrum characteristics, in which a voltage corresponding to the instantaneous inductor current is sampled and compared to a scaled sample of the rectified input AC line voltage. The line voltage sample modulates the inductor peak charge current in the envelope of the rectified AC voltage waveform. This drives the LED output voltage at a frequency of twice the input line voltage frequency, such that no flicker is perceived in the light output because the persistence in LED phosphor assists in averaging the flux output.

The present application claims the benefit of U.S. Provisional Application No. 60/983,043, filed on Oct. 26, 2007 which is hereby incorporated by reference in its entirety.

Numerous references including various publications are cited and discussed in the description of this invention. The citation and/or discussion of such references is provided merely to clarify the description of the present invention and is not an admission that any such reference is “prior art” to the present invention. All references cited and discussed in this specification are incorporated herein by reference in their entirety and to the same extent as if each reference was individually incorporated by reference.

### FIELD OF THE INVENTION

This invention relates to power supplies. More specifically, the present invention relates to regulated power supplies or ballasts integrated with a solid state light source such as Light Emitting Diodes (LEDs).

### BACKGROUND OF THE INVENTION

Ballasts are most commonly needed when an electrical circuit or device requires a current regulated power source. A ballast provides a positive resistance or reactance that limits the ultimate flow of current to an appropriate level. Common uses for ballasts are power conditioners for gas discharge lamps such as fluorescent, Xenon or Krypton lamps or LEDs.

The ballast as referred to herein includes circuitry from the alternating current (AC) power input up to but not including the load. The ballast will accept an AC power input, rectify the AC input voltage, and regulate the current fed to a load, such as one or more LEDs. The ballast can be realized in a variety of configurations and can provide compliance voltages greater or less than the instantaneous input voltage.

In all figures herein the output voltage of interest is the voltage across the LED. Input AC voltage, where shown, is at the terminals labeled AC1 and AC2. The power factor of an AC electric power system is defined as the ratio of the real power to the apparent power, and is a number between 0 and 1. Real power is the capacity of the circuit for performing work in a particular time. Apparent power is the product of the RMS current and voltage drawn across the input terminals AC1 and AC2, without taking into account the difference in phase angle between the current and voltage. Due to energy stored in the load and returned to the source, e.g., capacitance and inductance of the load, or due to a non-linear load that distorts the wave shape of the current drawn from the source, the apparent power can be greater than the real power. Low-power-factor loads are less efficient and increase losses in a power distribution system.

Ballasts which are directly connected to a 120 VAC power source, without intervening circuitry such as a transformer or filter, are commonly known as a direct off-line ballast. Such common direct off-line AC input ballasts in use today are typically of the configuration shown in FIGS. 1, 2 and 3. FIG. 1 is a buck configuration that will yield only output voltages lower than the instantaneous input voltage. FIG. 2 is a boost configuration and will yield only output voltages that are higher than the instantaneous input voltage. FIG. 3 is a buck-boost configuration that will supply output voltages higher, lower or the same as the instantaneous input voltage. The shaded box in FIGS. 1-3 is a switching power supply driver chip, for instance the Supertex Inc. HV9910 or equivalent. Other circuit variants are also possible without affecting the voltage and current delivered to the LED load. For instance the MOSFET switch M1 may be placed between the rectified AC voltage and inductor L1; or diode D1 can be placed after inductor L1 in FIG. 1 while still preventing capacitor C1 from discharging through the inductor L1; or the current sense resistor R1 can be connected to the drain of MOSFET switch M1.

Several problems exist with these conventional configurations. The first is with the rectifier bridge (D2-D5) and energy storage capacitor (C2). This combination is required to supply continuous power to the switching circuit, but this results in a poor power factor since high peak current is drawn from the input in a small phase angle. In this situation, rather than acting as a resistive load, no current is drawn by the ballast until the instantaneous AC line voltage is greater than the residual voltage on the capacitor C2. Second, the rectifier-capacitor front end (D2-D5 and C2) also delivers severely non-linear or intermittent performance when fed by industry standard solid state phase control dimming systems, wherein a silicon controlled switch such as a SCR or triac device is inserted in series with the ballast. On each half cycle of an AC waveform, the turn-on of the switch is delayed by a selectable amount from zero delay to a delay equal to a full half cycle of the AC line input. Zero delay produces full brightness from the LED load while any delay greater than zero dims the light to be a percentage of the “on” time divided by the half cycle time. The LED load will be “off” when the delay time equals the half cycle time. Since ballasts with typical rectifier/capacitor front ends only draw current during a small phase angle (i.e., only when the instantaneous AC line voltage exceeds the residual voltage on the capacitor), no dimming occurs during the part of the phase angle where no current is drawn. All of the dimming occurs during the small phase angle when current is drawn and the dimmer is rendered useless. Third, system efficiency is adversely affected by the large number of components in the main power path.

### SUMMARY OF THE INVENTION

A circuit design is presented for a high efficiency light source with an integrated ballast wherein a PWM control voltage is used to vary the voltage and current delivered to an LED load and, as a result, the alternating current drawn from the AC line. The alternating current is drawn by the circuit such that it has a similar waveform as the input AC voltage and with an improved harmony of phase. The circuit configurations described herein achieve improved power factor closer to unity, increase system efficiency and provide excellent performance. Performance with standard light dimming systems is also greatly enhanced.

Power factor correction as used herein is the process of increasing the power factor closer to unity. The ballast implements a power factor correction scheme in which the peak inductor current within the ballast is sampled by detecting the voltage developed across a sense resistor, and comparing it to a scaled sample of the rectified AC line voltage. The rectified AC line voltage has a frequency twice the frequency of the unrectified line voltage due to the inherent nature of the rectifier circuit, i.e., the rectified AC line voltage will have a frequency of 100 Hz or 120 Hz for an input line voltage of 50 Hz or 60 Hz, respectively. The PWM control output includes high voltage levels during which a MOSFET switch is on, and low voltage during which the MOSFET switch is off. When the MOSFET switch is on, current flow increases through an inductor and the switch back to the source. When the switch is off, the inductor current flow is directed through an LED load, and the current decreases with time. The line voltage sample modulates the envelope of the PWM control output, causing the envelope of the inductor current waveform to maintain approximately the same shape and phase as the envelope of the rectified AC voltage waveform. The inductor current drives the LED, therefore the LED is driven at a frequency equal to the rectified AC line voltage. No flicker is perceived by the eye in the light output because the frequency is above the perceived flicker rate and persistence in LED phosphor assists in averaging the flux output.

A device in accordance with an embodiment of the present invention preferably includes one or more of the following circuit design features or functions:

1) Modulating the output current and, as a result, the instantaneous output power in sympathy with the input voltage;

2) Combining the modulation technique with a non-fixed frequency PWM switching scheme;

3) Using a resistive divider to scale the voltage derived from the sampled current, thereby improving the current control and sensitivity to circuit value tolerance.

4) Improved response to common solid state dimming systems;

5) Elimination of the free-wheeling switching diode in certain current and load configurations;

6) A ballast integrally combined with the LEDs;

7) An optional current limiting capability;

8) An optional FET shunt used to improve circuit efficiency during periods of low current draw;

9) An optional high pass filter (HPF) used to slow the turn-on of the FETs during high peak currents, thereby improving the driver efficiency.

### BRIEF DESCRIPTION OF THE DRAWINGS

The present invention will be more readily understood from the detailed description of exemplary embodiments presented below considered in conjunction with the accompanying drawings, in which:

FIG. 1 is a circuit schematic of a prior art ballast in a buck configuration.

FIG. 2 is a circuit schematic of a prior art ballast in a boost configuration.

FIG. 3 is a circuit schematic of a prior art ballast in a buck-boost configuration.

FIG. 4 is a circuit schematic illustrating an embodiment of the present invention.

FIG. 5 is a graph of the measured LED current together with the voltage and current at input terminals AC1 and AC2 of the circuit of FIG. 4, for an embodiment of the present invention.

FIG. 6 is an alternate circuit schematic illustrating an improved current-sensing portion of the circuit of FIG. 4.

FIG. 7 is a graph of the measured voltage across the current sense resistor for the embodiment of the present invention shown in FIG. 4, showing the change in current through the switch as the input AC voltage varies.

FIG. 8 is a spectral plot of the current at input terminals AC1 and AC2 with and without varying PWM switching frequency.

FIG. 9 is a graph of the typical voltage and current output produced by a conventional solid-state dimmer supplying a purely resistive load, shown with a turn-on delay of one-quarter cycle of the AC line input.

FIG. 10 is an alternate circuit schematic for an alternate embodiment of the present invention, wherein the freewheeling diode is eliminated and the current steering is performed by the LED.

FIG. 11 is a circuit schematic of an alternate embodiment of the present invention, wherein the rectifier portion of the circuit is implemented using FETs.

FIG. 12 is a circuit schematic illustrating the preferred embodiment of the present invention, optimized for efficiency and size.

FIG. 13A-13B are circuit schematics of alternate circuit configurations for the front-end of the present invention illustrating improved efficiency.

FIG. 14 is a schematic of the comparator portion of an alternate embodiment of the present invention, illustrating a hysteretic switching scheme.

FIG. 15 is a timeline illustrating the onset of subharmonic oscillation.

### DETAILED DESCRIPTION OF THE INVENTION

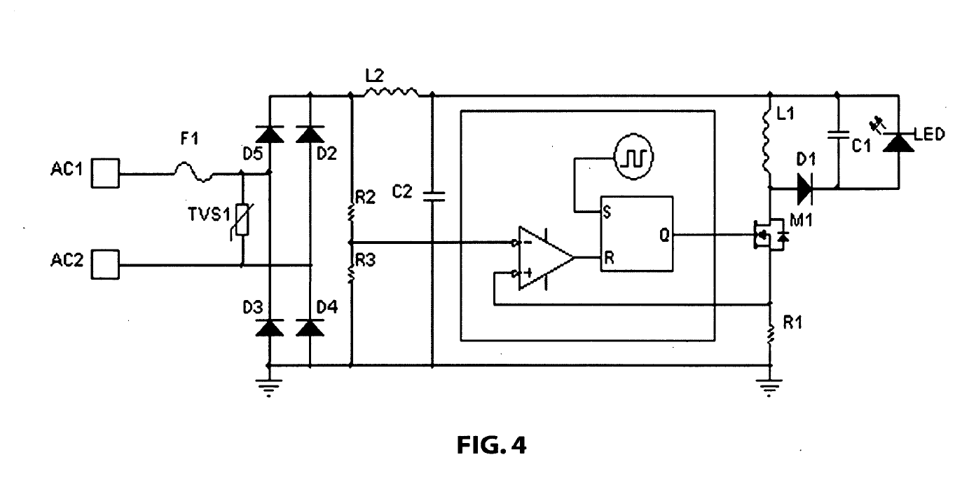

FIG. 4 is a schematic diagram showing an embodiment of the present invention. A buck-boost configuration is shown operating from an AC input voltage across input terminals AC1 and AC2, and driving an LED. For instance, with a 12 VAC input across AC1 and AC2, the LED may have a forward current of 400 mA and a forward voltage of 13 volts. A buck-boost topology is required since the rectified AC line voltage varies above and below the load voltage. The central portion of the circuit of FIG. 4 is enclosed in a box, wherein the box represents a switching power supply driver chip (“driver chip”), for instance the Supertex Inc. HV9910 or equivalent. The PWM generator of this driver chip may be represented functionally as an SR latch, oscillator, and comparator. The LED shown in all figures herein may also represent other kinds of loads, such as an array of LEDs or other type of solid state light source. A transient voltage suppressor (TVS) protects the circuit from voltage spikes on the AC1 and AC2 inputs arising from, for instance, electrostatic discharge.

The oscillator within the driver chip can operate in one of two modes depending upon the configuration of a control resistor external to the driver chip. First, if the control resistor is connected to ground, the oscillator operates at a fixed period that is a function of the resistance value, with a nominal duty cycle of 50%. The circuit of FIG. 4 is shown in this mode (control resistor not shown). The oscillator period is given by equation (1):

T_{OSC}(μs)=((R_{T}(kΩ)+22)/25), where R_{T} is the control resistance value. (1)

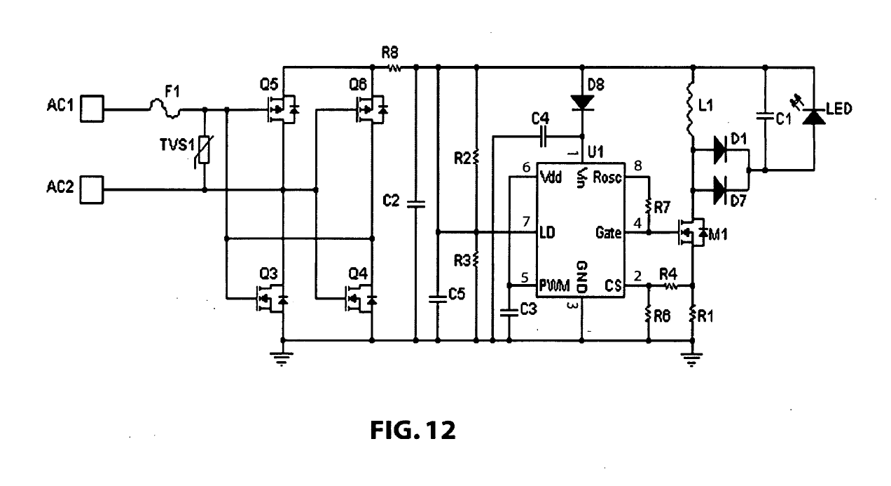

Second, if the control resistor is connected to the gate of the MOSFET switch M1, the oscillator operates with a fixed “off” time. The “off” time is given by T_{OSC}(μs) in equation (1). This second mode of operation will be discussed more fully below in relation to FIG. 12.

Diodes D2-D5 of FIG. 4 form a diode bridge rectifier which is well known in the art. All references herein to “rectifier output” shall refer to the junction of D2 and D5 with respect to ground potential, or to the equivalent circuit elements when in reference to a figure other than FIG. 4.

The power factor correction scheme begins by the oscillator connected to the SR latch driving the Q output high, thereby turning on switch M1 to make it conductive. The oscillator frequency is much higher than the frequency of the AC input voltage, typically in the range of 20 kHz to 300 kHz, and the oscillator period is the inverse of the frequency. The frequency of oscillation is set by a resistor (not shown in FIG. 4). When M1 is conductive, current begins flowing through inductor L1, switch M1 and current sense resistor R1. The LED is initially off because there is no current flow through it. Because inductor current cannot change instantaneously, and because the change in the rectified AC line voltage is minimal during the conduction time of M1, the current through L1 and R1 grows approximately exponentially during the conduction time of M1. The growth in the current through L1 and R1 can be further approximated as a linear growth because the conduction time of M1 is small compared to the time constant of the current through L1 and R1. The voltage drop across sense resistor R1 is used to sample the instantaneous current of inductor L1. This sense voltage is compared against a sample of the rectified AC line voltage across the divider formed by R2 and R3, wherein the divider ratio R3/(R2+R3) is scaled such that the peak voltage across R3 is equal to the peak desired current sense voltage across R1.

As the current through inductor L1 increases, the instantaneous voltage across resistor R1 soon equals the instantaneous input voltage sample across resistor R3. At that point in time, the comparator output becomes high, raising the R input to the SR latch, causing the Q output to go low, and turning off switch M1. Current flowing through inductor L1 then flows through diode D1 and the LED load, thus charging capacitor C1 and turning on the LED. The voltage across R1 drops to zero, causing the comparator output and the R input to the SR latch to go low. The Q output of the SR latch remains low until the next high interval of the oscillator connected to the S input to the SR latch. Once the oscillator goes high, the Q output of the SR latch goes high, turning on switch M1, and re-directing the current through L1 and R1, turning off the LED again. This cycle repeats for steady-state operation.

When the instantaneous input AC voltage as sampled across R3 is relatively low compared to its peak value, relatively little current has built up through L1, M1 and R1 while switch M1 is conductive (i.e., M1 is “on”) before the current sample voltage across R1 forces switch M1 to become nonconductive (i.e., M1 turns off). This is because the voltage across current sense resistor R1 rises quickly compared to the change in the voltage across R3, therefore, when the voltage across R3 is relatively small compared to its peak value, a relatively small amount of current through L1, M1 and R1 is required to make the voltage across R1 exceed the voltage across R3. This forces switch M1 to turn off, and a relatively low amount of current then flows though C1 and the LED as inductor L1 discharges.

However, when the instantaneous input AC voltage as sampled across R3 is relatively high compared to its peak value, a relatively large current builds up through L1, M1 and R1 while switch M1 is conductive before the current sample voltage across R1 forces switch M1 to become nonconductive. A relatively large amount of current then flows though C1 and the LED as inductor L1 discharges while switch M1 is off. For this reason the inductor L1 charges to a higher current when the input voltage as sampled across R3 is greater and a lower current when the input voltage as sampled across R3 is less. Therefore, this causes the AC current drawn by inductor L1 and discharged though the LED load to follow more closely the input AC voltage as sampled across R3, thereby improving the power factor because the voltage and current are more in-phase. By this method, the envelope of both the line voltage sample across R3 and the peak charge current through inductor L1 are modulated by the rectified AC voltage waveform.

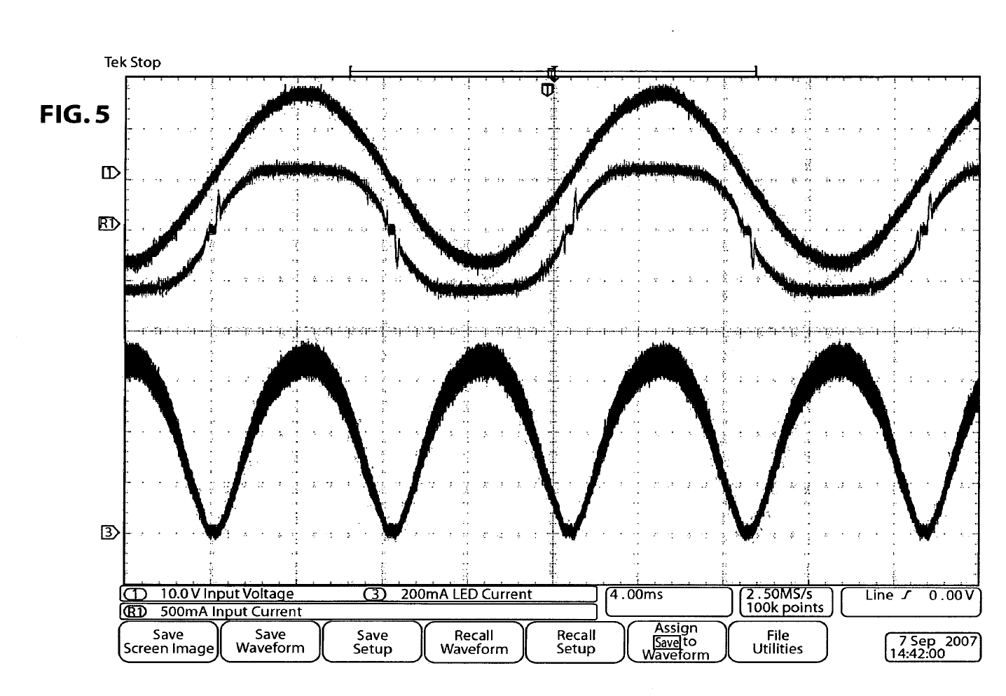

Let the input current be defined as the current entering the ballast from the input terminals AC1 and AC2 of FIG. 4. The envelope of the input current is modulated at the same rate as the AC input voltage, both of which are then rectified, causing the rectified current and voltage to have a frequency which is twice the AC input line voltage frequency. Let the average rectified input current be defmed as the average over time of the input current, averaged over an integral number of cycles of the rectified AC input voltage. The average rectified input current resulting from the method presented above is approximately 60% of the average current through resistor R1 set by the value of R1 and the R2-R3 divider. This is discussed more fully below in relation to FIG. 5.

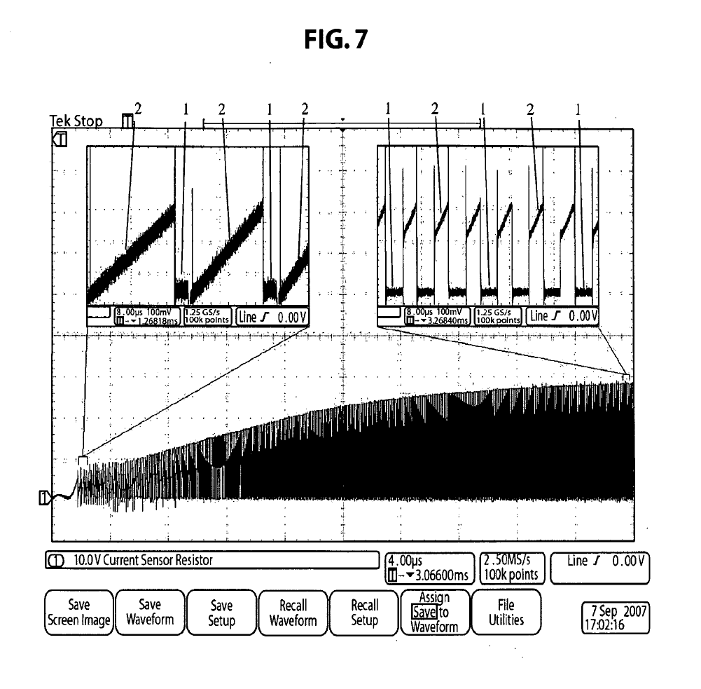

This modulation at 100 Hz or 120 Hz is not perceived in the light source since it is above the flicker rate detectable by the human eye and the persistence in LED phosphor assists in averaging the flux output over time. Optionally, depending on the phosphors employed, a small amount of capacitance (C1) across the light source will also assist in creating a more continuous light output. FIG. 5 shows time-based measurements of a circuit using one embodiment of the invention, in which the horizontal scale is 40 milliseconds (ms) end-to-end (4 ms per major division). In FIG. 5, the top trace is a plot of the input AC voltage across AC1 and AC2 using a vertical scale of 10V per major division; the middle plot is the forward current using a vertical scale of 500 mA per major division; and the bottom plot is the current through the LED using a scale of 200 mA per major division. Glitches in the forward current are caused by switching transients in diodes D2-D5 of FIG. 4. The envelope of the forward current is not quite a sine wave, but is limited at the extremes, giving it a clipped shape and producing an average forward current which is less than the forward current that would be expected by the value of resistor R1 and the R2-R3 divider. This is discussed further below in relation to FIG. 7. The ripple in the LED current is caused by inductor L1 and the desired PWM switching duty cycle. The PWM switching duty cycle is controlled by the combination of the charge time of the inductor L1 and the frequency of the oscillator, and varies with the envelope of the rectified AC voltage sampled across R3. Capacitor C2 and inductor L2 serve as an L-C filter to smooth the PWM switching frequencies.

Preferably, the power factor correction scheme described above may be integrated into any circuit using a PWM control IC, for instance the Supertex HV9910 or equivalent, that allows direct access to the comparator reference within the IC. However, if access to the comparator reference is not available, a modified power factor correction scheme may be implemented by summing the rectified line voltage sample across R3 with the voltage across the current sense resistor R1, and using this sum as the R input to an SR latch.

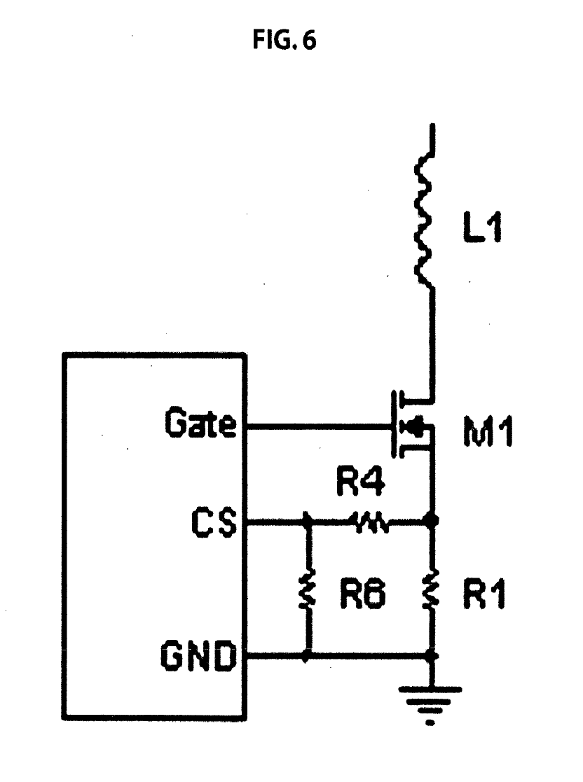

The current sense resistor R1 is typically a low value resistor that is available only in large value increments (e.g., 47 mΩ, 50 mΩ, 75 mΩ, 100 mΩ, etc.), resulting in a relatively coarse ability to design the current sensing circuitry if the voltage across resistor R1 is used directly. FIG. 6 is an improved circuit schematic of the output current sensing portion of the present invention. Resistors R4 and R6 are connected in series so as to be in parallel to resistor R1 such that the voltage across resistor R6 is scaled from the voltage across resistor R1 by the ratio of R6/(R4+R6). The voltage across R6 is then used as the current sense voltage for the power factor correction scheme. The resistances of R4 and R6 are very high compared to R1, so most of the current through switch M1 when M1 is on will flow through resistor R1 and a negligible amount of current will flow through resistors R4 and R6. In this way, the sense voltage across resistor R6 will be very close to the sense voltage which would have been developed across resistor R1 by itself. The impedance of the CS port in FIG. 6 is extremely high compared to R4 and R6, so essentially no current flows into the CS port. Larger value resistors like R4 and R6 can be precision low power resistors available in relatively smaller resistance value increments, thereby allowing extremely fine scaling of the voltage across current sense resistor R1 to any desired set point by using an appropriate combination of resistors R4 and R6. The equivalent resistance of resistor R1 in parallel with the series resistance (R4+R6) is given by equation (2):

Equivalent Resistance=[(1/R1)+(1/(R4+R6))]⁻¹ (2)

In equation (2), R1, R4, and R6 refer to the resistance values of those resistors, respectively.

For example, a divider resistance (R4+R6) of 1000 Ω, used in parallel with a 100 mΩ sense resistor R1, produces an equivalent resistance of 99.99 mΩ, thus introducing an error of only 0.01%, but providing sufficiently low impedance to give good noise immunity. The scaled current sense voltage CS is then used as the positive-side comparator input to the comparator shown in FIG. 4. It will be understood that any reference herein in the power factor correction scheme to current sensing by detecting the voltage across current sense resistor R1 will apply equally to a method of control using current sensing by detecting the voltage across R6 in the resistive divider formed by R4-R6.

With a PWM switching driver circuit employing a fixed frequency oscillator, spurious frequency components on the voltage signal at the input of the LED load include the fundamental frequency of the switching oscillator and harmonics of the fundamental frequency. These spurious components must be filtered in order to minimize conducted and radiated electromagnetic interference. Filtering for the embodiment of the present invention shown in FIG. 4 is performed by inductor L2 and capacitor C2. Filtering for the embodiment of the present invention shown in FIG. 12 is performed by resistor R8 and capacitor C2. However, the spurious components have significant spectral power density and can be difficult to filter effectively, thereby allowing unwanted conducted electromagnetic interference to be coupled back onto the AC input, or allowing unwanted radiated electromagnetic emissions.

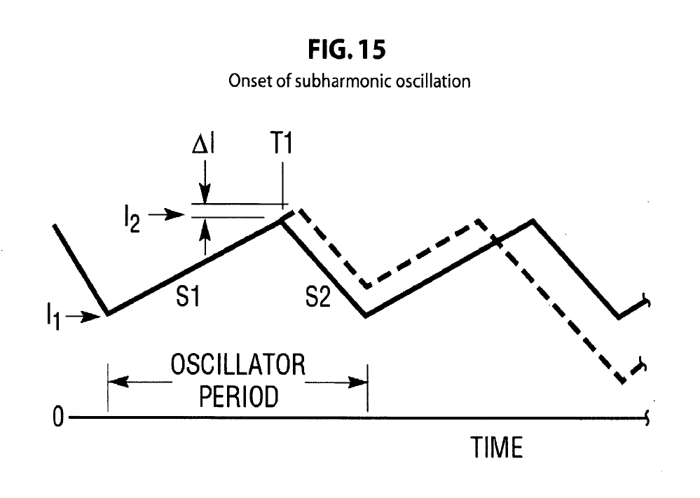

Subharmonics of the fundamental frequency are another problem of current controlled or current regulated PWM systems known in the art and operating with a fixed frequency oscillator. Such systems suffer a stability problem of switching to a subharmonic frequency when the switching duty cycle, i.e., the portion of time that the pulse is high, exceeds half the cycle time. FIG. 15 illustrates this situation, in which the increasing slope S1 of the inductor ripple current is less than the decreasing slope S2. The inductor ripple current starts at I₁, at the beginning of each oscillator switch cycle. Inductor current increases at a rate S1 until the inductor current reaches the control trip level I₂. The PWM controller then disables the switch and the inductor current begins to decrease at a rate S2. If the current switch point (I₂) is perturbed slightly and increased by ΔI, the time left for the current to fall is reduced so that the minimum current point is increased by ΔI+ΔI×S2/S1. This will cause the minimum current on the next cycle to decrease by (ΔI+ΔI×S2/S1)(S2/S1). On each succeeding cycle the current perturbation is multiplied by S2/S1. The system is unstable if S2/S1 is greater than 1. The condition S2/S1≧1 occurs at a duty cycle of 50% or higher.

The subharmonic instability is detected as a duty cycle asymmetry between consecutive pulses driving the load. Detrimental effects include: causing the average output current through the load to drop; increasing the output ripple current; severely non-linear or intermittent operation caused by switching to a subharmonic frequency; and a more difficult filter design to prevent conducted and radiated electromagnetic interference.

In contrast, the present invention is less susceptible to subharmonic oscillation because the LED load is not driven at a fixed PWM switching frequency. The PWM switching frequency will vary as a function of the instantaneous rectified AC input voltage at the output of the bridge rectifier, while maintaining a fixed off-time. The PWM switching frequency is low when the instantaneous rectified AC input voltage is relatively low because inductor L1 charges more slowly with a lower input voltage. Conversely, the PWM switching frequency is relatively higher when the instantaneous rectified AC input voltage is relatively higher. This is discussed further in relation to FIG. 7. The off-time is fixed, during which time inductor L1 always discharges at approximately the same rate because the forward bias output voltage across the LED is always approximately the same value. A constant discharge rate of inductor L1 is conducive to using a fixed PWM off-time system. The discharge rate is constant because the LED requires approximately 11 volts forward bias across the LED to begin conducting current, and as the current through the LED rises to approximately 1 ampere, the forward bias voltage across the LED rises to only approximately 13V; therefore the inductor discharge time (i.e., PWM off-time) is substantially constant.

As the rectified AC input voltage varies, the duty cycle and PWM switching frequency are altered smoothly. Combining this PWM frequency scheme with the power factor correction scheme modulates the PWM switching frequency over each quarter cycle of the AC line frequency as discussed further in relation to FIG. 7. Because there is no fixed PWM switching frequency, there is no subharmonic that can be the source of instability, and therefore the system is unconditionally stable. See Unitrode Application Note U-97, Modelling, Analysis and Compensation of the Current-Mode Converter. See also Supertex Application Note AN-H50, Constant, Off-time, Buck-based, LED Drivers Using the HV9910B. Embodiments of the present invention may include a combination of the PWM frequency scheme with the power factor correction scheme.

FIG. 12 is a schematic diagram for a preferred embodiment of a system combining the PWM frequency scheme with the power factor correction scheme. The shaded box in the center is a PWM controller, Supertex HV9910 or equivalent. The PWM controller is shown with the following connections with the surrounding circuit: Vdd is an internally regulated supply voltage, 7.5 volts nominal. LD is the linear dimming input, which controls the dimming by changing the current limit threshold at the internal current sense comparator. PWM is a binary enable function which may be used for on/off control or PWM dimming via an external source. Rosc is the oscillator control, connected to a control resistor R7. When the control resistor R7 is connected to the gate of MOSFET switch M1 as shown in FIG. 12, the resistance R7 controls the “off” time of the internal oscillator. “Gate” is the output of the controller, used to control the gate input of the MOSFET switch M1 external to the PWM controller. CS is the current sensing input, which is the voltage developed across the current sensing resistor R1, or the finely tuned resistance network formed by R1-R4-R6.

FIG. 7 is a time-based plot of voltage across the sense resistor R1 in the circuit of FIG. 12, with the lower trace displayed at 100 mV per vertical major division and 400 μs per horizontal major division. The lower portion of FIG. 7 shows the voltage across sense resistor R1, over a time duration equal to one quarter-cycle of the input AC voltage across AC1 and AC2 (equivalent to one half-cycle of the rectified input AC voltage), covering the interval from when the input AC voltage crosses zero to when it reaches its peak amplitude. The upper left portion of FIG. 7 is an expanded view of the lower left portion of FIG. 7, and shall be referred to here as the left inset view. The upper right portion of FIG. 7 is an expanded view of the lower right portion of FIG. 7, and shall be referred to here as the right inset view. The left inset view and the right inset view shall be referred to collectively as the inset views. The inset views of FIG. 7 are displayed at 8 μs per horizontal major division, with 20 mV per vertical major division in the left inset view and 100 mV per vertical major division in the right inset view.

The inset views of FIG. 7 show discharging intervals 1 in which the voltage across the current sense resistor R1 is low because switch M1 is off and the current flows through L1, D1 and the LED. During charging intervals 2 when the voltage across the current sense resistor R1 ramps up, switch M1 is on and current flows through L1, M1 and R1, rather than through the LED, and the LED is off. For sake of clarity, not all discharging intervals 1 or charging intervals 2 are labeled in FIG. 7. The current through resistor R1 at the beginning of each charging interval 2 may be discontinuous with the preceding discharging interval 1, as seen in the right inset view, if inductor L1 has not completely discharged through the LED during a discharging interval 1. The charging interval 2 terminates when the voltage across the current sense resistor R1 exceeds the envelope of the input AC waveform across R3, at which time the comparator within the HV9910 or equivalent forces the “R” input of the SR latch high, thus turning off switch M1.

A charge/discharge cycle is formed by the combination of a variable-duration charging interval 2 and a fixed-duration discharging interval 1. The duration of the discharging intervals 1, when switch M1 is off, is set by the control resistor R7. The current through inductor L1 and sense resistor R1 increases with an approximately exponential growth curve during charging intervals 2. The frequency of the charge/discharge cycle, which is also called here the PWM switching frequency, varies in FIG. 7 from approximately 51 kHz in the left inset to approximately 157 kHz in the right inset, over a quarter-cycle of the input AC voltage. The switching frequency increases for two reasons: First, when the instantaneous AC voltage at the input of L1 is larger, the entire exponential growth curve rises more steeply. This can be seen in the left inset view, in which the second charging interval 2 has a shorter duration than the first charging interval 2. Second, if the inductor L1 has not completely discharged during a discharging interval 1, then the current through current sense resistor R1 during the next charging interval 2 starts at a higher starting point on the exponential growth curve. This can be seen in the right inset view, in which the start of each charging interval 2 is discontinuous with the end of the preceding discharging interval 1.

If inductor L1 has not fully discharged during a discharging interval 1, the amount of input rectified current that inductor L1 needs to draw to become fully charged is relatively insensitive to the instantaneous rectified AC voltage. This accounts for the flat shape of the input current in the middle plot of FIG. 5.

After the end of the time period shown in FIG. 7, the voltage envelope returns to near zero during the next quarter-cycle of the input AC voltage, with an accompanying change in PWM switching frequency. This cycle repeats for steady- state operation.

The effect of imparting onto the output current a dynamic variation in the PWM switching frequency, with the switching frequency being very high relative to the fundamental frequency of the rectified AC input voltage, is to spread out the frequency spectral components of the input current waveform and thereby mitigate the amplitude of any single harmonic spurious outputs. The spreading effect of the frequency spectral components is similar to that of radio systems employing pseudo-noise spread spectrum modulation systems as described in references such as Torrieri, “Principles of Spread-Spectrum Communication Systems,” ISBN 0387227822. Therefore, the present invention provides an additional benefit of mitigating the effect of higher-order spectral content by modulating the time characteristics of the charge times as shown in FIG. 7.

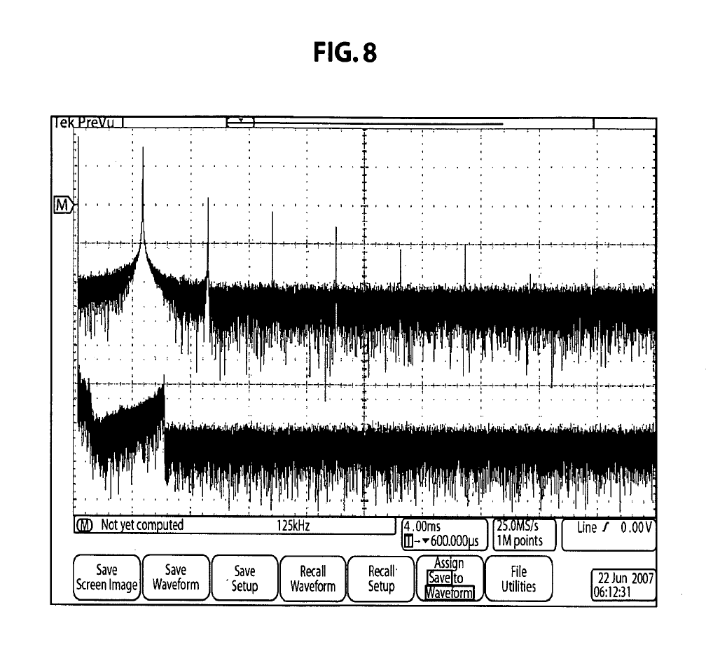

FIG. 8 illustrates the mitigation of the high-order spectral content. The top trace of FIG. 8 is a spectral plot of the input AC line voltage fed by a 12 VAC line, using the circuit of FIG. 4 operating with a fixed PWM frequency of 157 kHz. The bottom scan shows the same plot but with the power factor correction and constant off time implemented. The top scan shows distinct spurious frequency energy 3 at 157 kHz, 314 kHz, 471 kHz, etc. The bottom scan shows no significant spectral components above the noise floor.

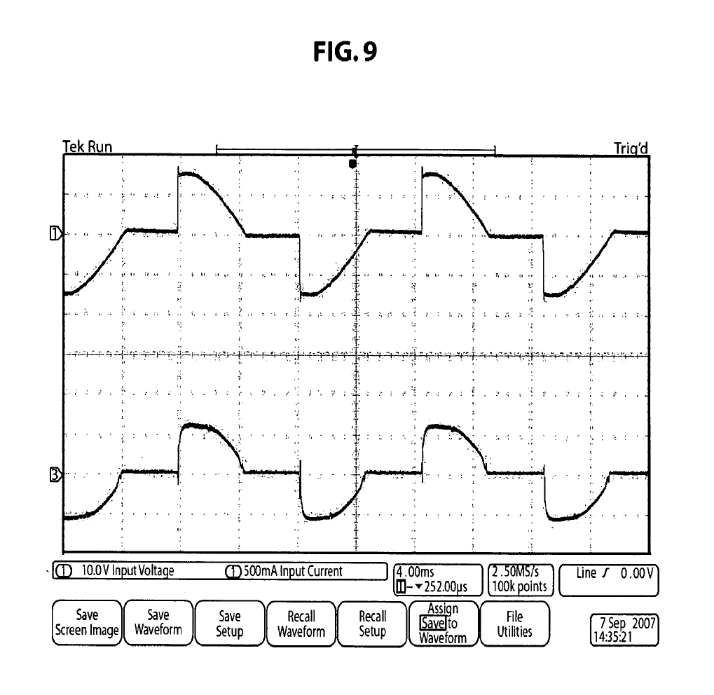

A load on an AC-fed circuit will behave like a purely resistive load when the circuit has a unity power factor, with the input current having the same phase and waveform as the input voltage. The power factor correction scheme with constant off time described herein has the benefit of delivering a near unity power factor when used with either standard solid state or resistive dimming systems. Solid state dimmers use a silicon controlled rectifier or triac device to vary the delay time before the AC line is switched on to vary the RMS voltage delivered to a purely resistive load such as a light bulb. For instance, FIG. 9 shows a time-based plot of voltage (top trace) and current (bottom trace) output of a conventional solid-state dimmer supplying a purely resistive load. The flat horizontal portions of each trace are intervals when the voltage or current, respectively, have been switched off by the conventional solid state dimmer This repeats each half cycle as shown in FIG. 9. The power factor correction circuit of the present invention forces the input current to mimic the waveform and phase of the input voltage, just as a resistive load does naturally.

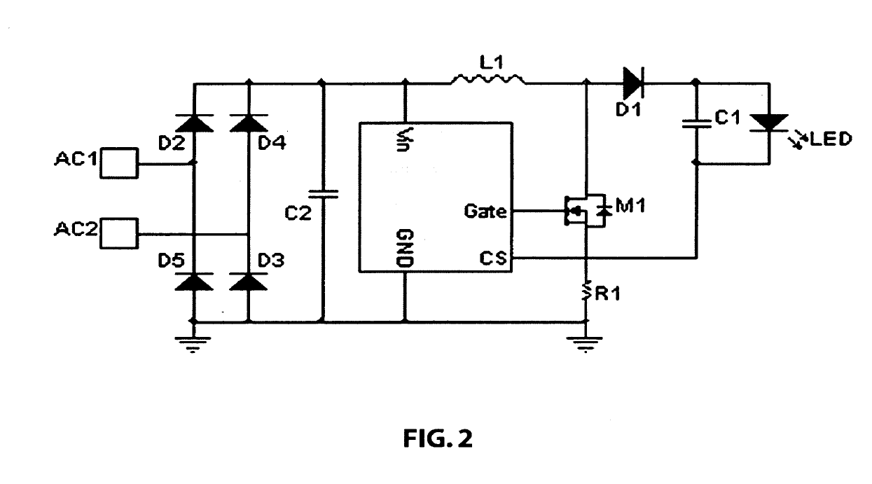

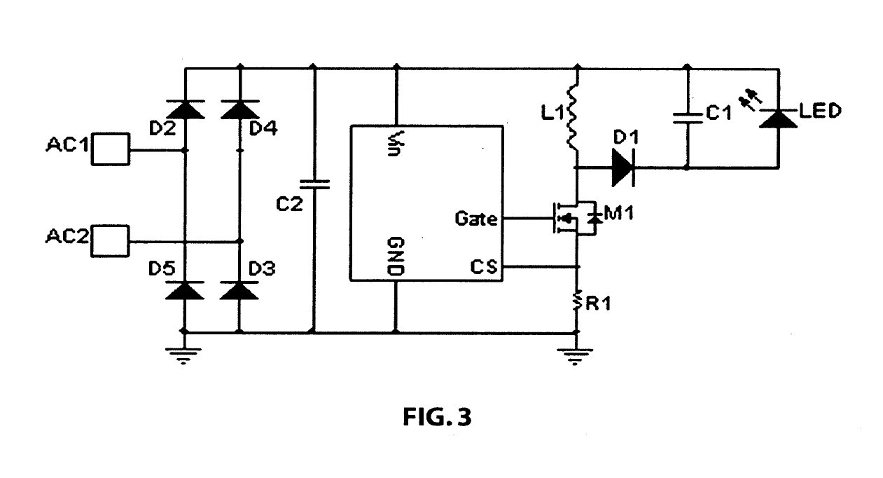

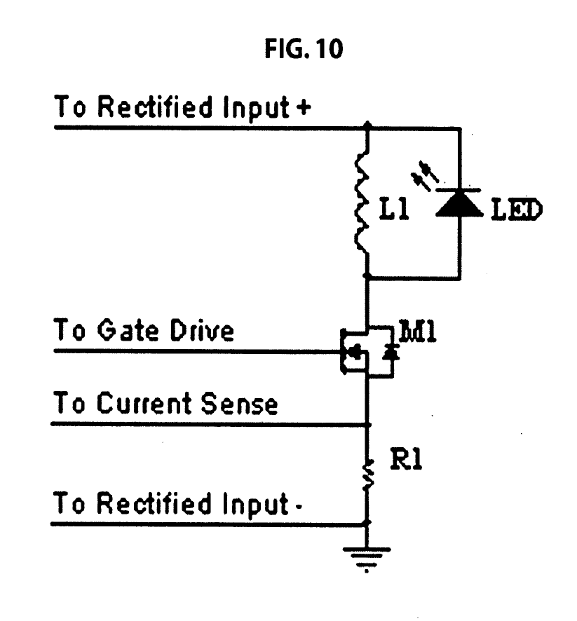

Although an LED is not optimized for switching, it is still a rectifier and can be exploited as such. Referring to FIGS. 2 and 3, diode D1 serves only to prevent depleting charge from capacitor C1 when the N-channel MOSFET switch M1 is conducting. Capacitor C1 is typically optional since current ripple at the PWM switching frequency may be too rapid to be perceived by the human eye. The PWM ripple in the inductor current could be as much as 100%, allowing the inductor L1 to totally discharge before the next charge cycle. This is a common operating mode called discontinuous inductor current mode. In FIG. 4, if the L1 inductor current was allowed to become discontinuous and there were no capacitor C1, there would be no current through the LED. As a result, the LED would already be turned off, no charge across the forward-biased LED would need to be depleted and, for a boost converter, no voltage would need to be blocked by diode D1. Therefore, the output portion of the circuit of FIG. 4 could be simplified by eliminating C1 and diode D1, thereby eliminating the conduction losses of D1. The resulting output portion of the circuit is shown in FIG. 10.

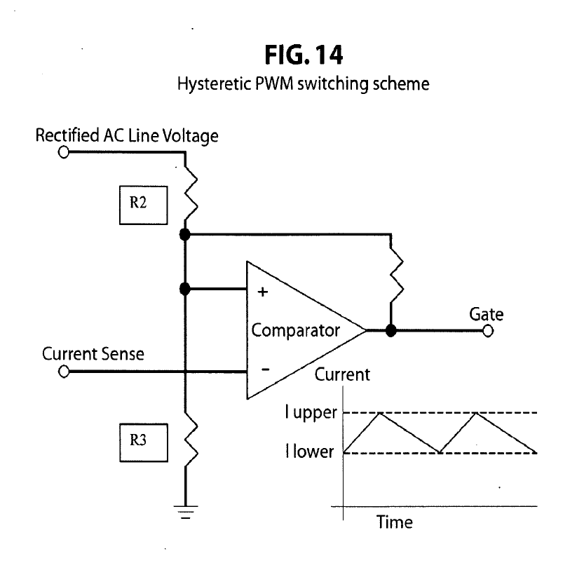

In an alternative embodiment, the variable PWM switching frequency may also be achieved by using a hysteretic PWM switching scheme, in which the opening and closing of switch M1 is in direct response to the sensed current (i.e., the voltage across R1) reaching an upper and lower bound, and is not synchronous with any clock. This is a hysteretic controller as shown in FIG. 14. A hysteretic controller is a self-oscillation circuit that regulates an output voltage by keeping the output voltage within a hysteresis window set by a reference voltage regulator and comparator. The upper and lower limits of this hysteresis window will be referred to herein as the upper and lower hysteresis limits, respectively. The actual output ripple voltage is the combination of the hysteresis voltage, overshoot caused by internal delays, and the output capacitor characteristics.

The operation of the circuit of FIG. 14 begins with the Gate line high, connected to the gate of switch M1 (not shown). The voltage at the “+” input to the comparator is the superposition of the voltage of the rectified AC line voltage scaled by R3/(R2+R3) plus the voltage of the comparator output. The voltage across current sense resistor R1 is connected to the “−” input of the comparator. The current sense voltage is initially increasing at a faster rate of change than the rate of change of the rectified AC line. When the voltage of the current sense input equals the voltage at the “+” input to the comparator, the comparator turns off the MOSFET by bringing Gate to ground. The voltage at the “+” input to the comparator drops to the lower hysteresis limit, which is less than the current sense voltage. Inductor L1 (not shown) discharges and the L1 current follows the current profile shown in the inset of FIG. 14. The L1 inductor current ramps down until it reaches the lower hysteresis limit at the “+” input to the comparator. The comparator changes state and the circuit starts over again. The resulting inductor current is shown in the inset view of FIG. 14.

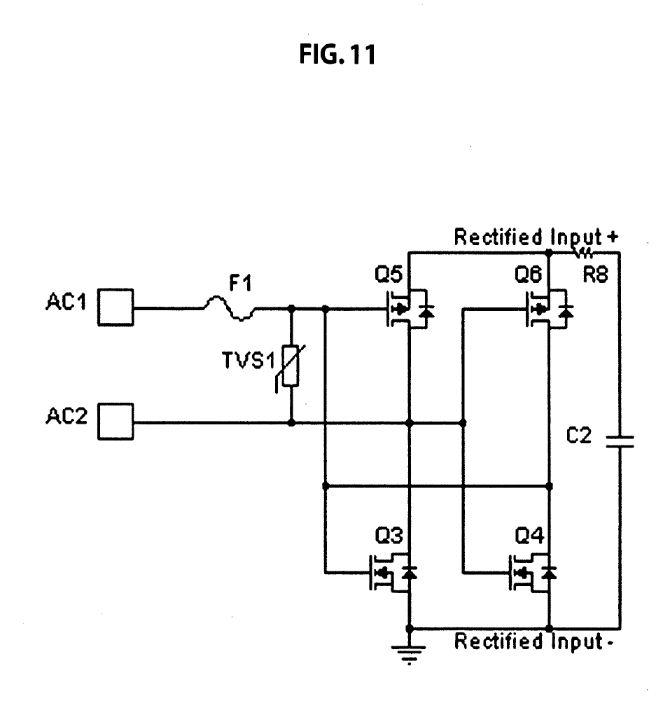

FIG. 11 shows an alternate circuit having improved efficiency in the input rectifier section, in which a bridge consisting of four FETs Q3-Q6 may be used instead of a typical diode bridge, thus avoiding the losses associated with a typical diode bridge. FETs Q5 and Q4 turn on when AC2 is low relative to AC1 during the positive half-cycle of the input AC waveform. FETs Q3 and Q6 turn on when AC2 is high relative to AC1 during the negative half-cycle of the input AC waveform. FETs Q3-Q6 are placed in a backward configuration such that current flows from the source to drain, instead of drain to source. This orients the inherent diode formed between the gate and the source or drain in such a way that current cannot flow backwards from the input capacitor when any of the FETs Q3-Q6 are off, and current can flow forward to the capacitor before the gate of any of the FETs Q3-Q6 that are conducting has reached the threshold voltage. When the FETs are conducting (two at a time, one P-type and one N-type) a smaller loss is seen in the bridge than with a conventional diode bridge.

Several problems exist when an electronic transformer is attached to the AC1 and AC2 inputs of FIG. 4. First, electronic transformers are equipped with open and short circuit protection, begin operation at voltages approximately in the range of 8V-10V, and switch polarity at high frequencies relative to the frequency of the input signal to the electronic transformer. However, when the transformer begins to conduct at 10V, the input capacitor C2 demands a surge of current to reach equilibrium of the voltage across C2 with the voltage across the rectifier output. This current surge causes the transformer to see a short circuit and causes the transformer to shut down. Second, when the voltage across the capacitor has reached equilibrium with the voltage across the rectifier output, it no longer needs to be charged so the transformer sees an open circuit and starts to shut down. Third, as the voltage reverses polarity the capacitor sees lower input voltage and discharges through the FETs.

To solve these problems, the present invention includes a resistor R8 placed in series with the switching circuitry after the rectifier bridge. This resistor is shown in FIG. 12 as R8 which, alternatively, may be an inductor (not shown). Resistor R8 or the equivalent inductor reduces the startup surge current, preventing a short circuit shut-down. It also prevents the capacitor C2 from becoming fully charged too early, avoiding an open circuit shut-down. Lastly, the resistor R8 suppresses the reverse current surge from the capacitor C2 when the AC input lines AC1 and AC2 switch polarity. FIG. 12 shows a circuit incorporating these circuit design elements.

Significant benefits of lower parasitics, lower charge time and lower peak current can be realized when the ballast is matched in terms of the voltage and current required to drive the LED load to a specific LED configuration and integrated into one package. The printed circuit, chip-on-board, hybrid circuit techniques used to construct an LED light source is also well suited to constructing a high power density ballast. Designing a ballast that is optimized to drive one specific load allows one to maximize system efficiency and minimize system size.

A device in accordance with an embodiment of the present invention preferably includes one or more of the following circuit design features:

The output current is modulated having an improved harmony of phase with the input voltage, thereby producing an improved power factor which may approach a near unity power factor. The instantaneous output power helps maximize efficiency for an AC powered system.

Combining the output current modulation with a non-fixed frequency PWM switching scheme spreads the spectrum of the switching transients and minimizes conducted and radiated electromagnetic interference.

The inclusion of a resistive divider formed by R4 and R6 of FIG. 6, thereby allowing finer scaling of the voltage from the sampled current measured across the sense resistor R1.

Output light flicker from the LED is smoothed to a level not perceptible by the human eye when a solid state dimming system provides the input voltage to the AC1 and AC2 inputs, thereby resulting in an LED which responds as an incandescent light bulb would respond to a common solid state dimming system.

Optionally, the present invention eliminates the need for a free-wheeling switching diode, shown as diode D1 in FIGS. 2-3, in certain input voltage versus load configurations and when using a discontinuous L1 inductor current, thereby improving efficiency. D1, when present otherwise, allows the inductor L1 to keep current moving through L1 when L1 turns off, but does not require capacitor C2 to discharge.

Combining the ballast with the LED light sources in one circuit, thereby reducing the cost and size of the circuit. The ballast, as described here, includes the components shown in FIG. 4 or 12 from the AC1 and AC2 inputs up to but not including the LED load.

Providing current limiting at the output of the rectifier section for applications requiring electronic input power transformers by adding resistive element R8 or an equivalent inductance (not shown) to the output of the rectifier section as shown in FIG. 12. This feature prevents some electronic transformers from unwanted shutdown that would otherwise occur if a brief high peak current is drawn from the electronic transformer.

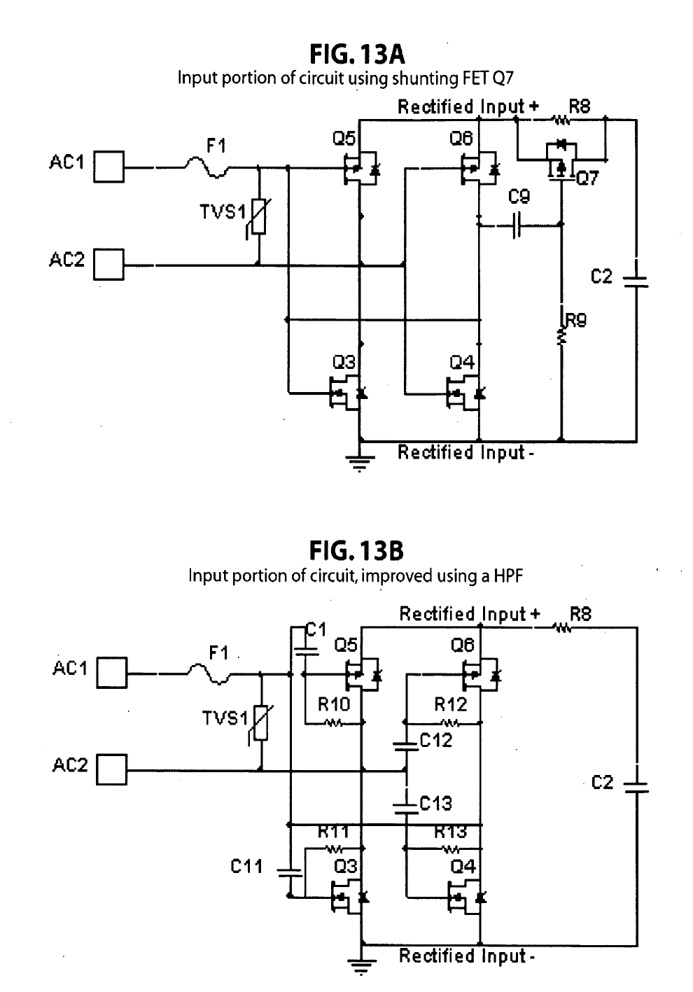

Optionally, resistor R8 in FIG. 12 may be shunted with a FET that is biased on during periods of low current draw, as shown in FIG. 13a, thereby improving circuit efficiency. Optionally, resistor R8 may be eliminated and replaced with a high pass filter (HPF) across the gate of the rectifier bridge FETs Q3 through Q6 as shown in FIG. 13b. The HPF slows the turn-on of the FETs Q3-Q6 during high peak currents. The slow turn-on reduces the peak current that may otherwise shut down the electronic transformer. The elimination of resistor R8 improves the driver efficiency during low current periods when using an electronic transformer and continuously when using a magnetic transformer which does not operate on PWM principles.

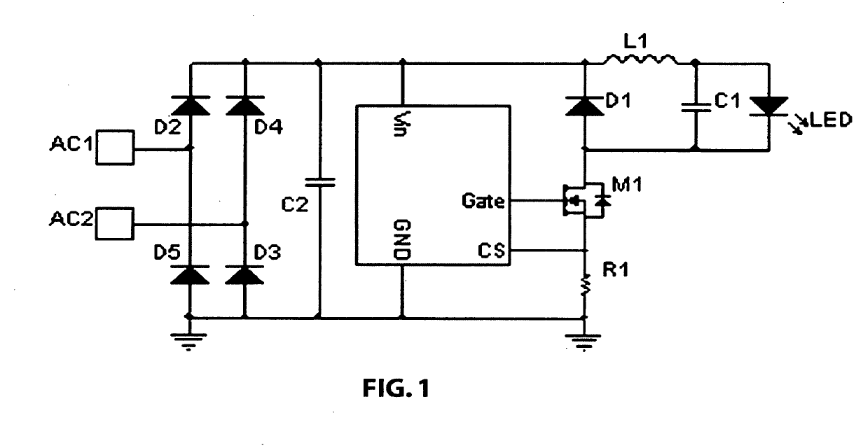

A conventional buck transformer uses a resistor as a monitor for the inductor current, as shown in FIG. 1. An optional improvement of the present invention is shown in FIG. 6 where a resistive divider is made up of R4, R1 and R6. The addition of these resistors provides more precise current sensing because of the wide variety and availability of large value resistors. This method also decreases the sensitivity of the current monitor to resistor value tolerance.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application may disclose several numerical range limitations. Persons skilled in the art would recognize that the numerical ranges disclosed inherently support any range within the disclosed numerical ranges even though a precise range limitation is not stated verbatim in the specification because this invention can be practiced throughout the disclosed numerical ranges. The entire disclosure of the patents and publications referred in this application are hereby incorporated herein by reference.

1. An efficient light source apparatus with integrated ballast, comprising:
a rectifier having a rectifier input and a rectifier output, the rectifier being configured to convert an input AC voltage to produce at the rectifier output a modulated voltage waveform with respect to a reference potential;
a filter having a filter input and a filter output, the filter input connected to the rectifier output, the filter producing at the filter output a filtered modulated voltage waveform;
a resistive divider circuit connected to the rectifier output and configured to produce a first sensed voltage corresponding to a portion of the modulated voltage waveform at its output;
a comparator circuit having a first comparator input connected to the first sensed voltage, a second comparator input, and a comparator output, wherein the comparator output is HIGH if a voltage at the second comparator input is greater than the first sensed voltage, and the comparator output is LOW if the voltage at the second comparator input is less than the first sensed voltage;
a pulse-width modulator circuit, having a pulse-width modulator input connected to the comparator output, and a pulse-width modulator output, the pulse-width modulator configured to produce a modulated control signal at the pulse-width modulator output, in response to the comparator output;
a reactive load having a first port and a second port, the first port configured to receive the filtered modulated positive voltage waveform, the reactive load including an LED;
a switch having a switch input and a switch output, the switch input connected to the second port of the reactive load, the switch controlled by the modulated control signal to selectively connect the switch input to the switch output; and
a current sense circuit having a first terminal and a second terminal, the first terminal connected to the switch output, and the second terminal connected to the reference potential, the current sense resistance producing a second sensed voltage between the first terminal and the second terminal, wherein the second sensed voltage is connected to the second comparator input.

2. The apparatus of claim 1, wherein the pulse-width modulator is configured to track an envelope of the control signal in response to the comparator output.

3. The apparatus of claim 1, wherein the current sense circuit comprises a second resistive divider, producing a divided current sense voltage, wherein the divided current sense voltage is provided as the second sensed voltage.

4. The apparatus of claim 1, wherein the pulse-width modulator oscillates at a fixed predetermined frequency.

5. The apparatus of claim 1, wherein the pulse-width modulator ON/OFF state modulates the modulated control signal to oscillate at a variable rate predetermined by the amplitude of the second sensed voltage.

6. The apparatus of claim 1, the filter comprising an inductor-capacitor-type filter comprising an inductor and a capacitor, a first port of the inductor connected to the rectifier output, a second port of the inductor connected to a first port of the capacitor, a second port of the capacitor connected to the reference potential, and the second port of the inductor forming the filter output.

7. The apparatus of claim 1, the filter comprising a resistor-capacitor-type filter comprising a resistor and a capacitor, a first port of the resistor connected to the rectifier output, a second port of the resistor connected to a first port of the capacitor, a second port of the capacitor connected to reference potential, and the second port of the resistor forming the filter output.

8. The apparatus of claim 7, further comprising a shunt in parallel with the resistor of the filter, the shunt configured to be biased on during periods when a current level through the resistor is below a predetermined threshold.

9. The apparatus of claim 1, wherein the rectifier comprises a plurality of FETs, and further comprising a high pass filter across a gate of at least a portion of the plurality of FETs.

10. A method for efficiently producing light, with integrated ballast, comprising the steps of:
rectifying by use of a rectifier having a rectifier input and a rectifier output, the rectifier input connected to an input AC voltage, the rectifier converting the input AC voltage to produce at the rectifier output a modulated positive voltage waveform with respect to a reference potential;
filtering by use of a filter having a filter input and a filter output, the filter input connected to the rectifier output, producing a filtered modulated voltage waveform, the filter configured to reduce unwanted spectral energy;
sensing by use of a resistive divider circuit having a resistive divider circuit input and a resistive divider circuit output, the resistive divider circuit input connected to the rectifier output and the resistive divider circuit output connected to the reference potential, configured to produce a first sensed voltage corresponding to a portion of the modulated voltage waveform;
comparing by use of a comparator circuit having a first comparator input connected to the first sensed voltage, a second comparator input, and a comparator output, wherein the comparator output is HIGH if a voltage at the second comparator input is greater than the first sensed voltage, and the comparator output is LOW if the voltage at the second comparator input is less than or equal to the first sensed voltage;
pulse-width modulating by use of a pulse-width modulator circuit, having a pulse-width modulator input connected to the comparator output, and a pulse-width modulator output, the pulse-width modulator configured to produce a modulated control signal at the pulse-width modulator output, in response to the comparator output;
exciting a reactive load having a first port and a second port, the first port configured to receive the filtered modulated positive voltage waveform, the reactive load including an LED;
switching by use of a switch having a switch input and a switch output, the switch input connected to the second port of the reactive load, the switch controlled by the modulated control signal; and
sensing by use of a current sense circuit having a first terminal and a second terminal, the first terminal connected to the switch output, and the second terminal connected to the reference potential, the current sense circuit producing a second sensed voltage between the first terminal and the second terminal, wherein the second sensed voltage is connected to the second comparator input.

11. The method of claim 10, further comprising the step of tracking an envelope of the control signal in response to the comparator output.

12. The method of claim 10, further comprising the step of dividing the voltage across the current sense circuit by a second resistive divider, producing a divided current sense voltage, wherein the divided current sense voltage is provided as the second sensed voltage.

13. The method of claim 10, further comprising the step of oscillating the pulse- width modulator at a fixed predetermined frequency.

14. The method of claim 10, further comprising the step of ON/OFF modulating the modulated control signal at a variable rate predetermined by the amplitude of the second sensed voltage.

15. The method of claim 10, wherein the filter comprises a resistor-capacitor- type filter comprising a resistor and a capacitor, a first port of the resistor connected to the rectifier output, a second port of the resistor connected to a first port of the capacitor, a second port of the capacitor connected to the reference potential, and the second port of the resistor forming the filter output, further comprising the step of shunting in parallel with the resistor of the filter, the shunt configured to be biased on during periods when a current level through the resistor is below a predetermined threshold.

16. The method of claim 10, wherein the rectifier comprises a plurality of FETs, further comprising the step of high-pass filtering a gate of at least a portion of the plurality of FETs.
